(19) United States
(12) Patent Application Publication
(10) Pub. No.: US 2015/0137582 A1
(43) Pub. Date: May 21, 2015

(54) WHEEL COVER ASSEMBLY

(71) Applicant: BikeDubz Inc., Dallas, TX (US)

(72) Inventor: Harry Culiver, III, Dallas, TX (US)

(21) Appl. No.: 14/543,295

(22) Filed: Nov. 17, 2014

Related U.S. Application Data
(60) Provisional application No. 61/962,767, filed on Nov. 15, 2013.

(51) Int. Cl. B60B 7/02; B60B 7/00

(52) U.S. Cl. CPC B60B 7/02; B60B 7/0006; B60Y 2200/13; B60B 2900/331
USPC 301/37.105

(57) ABSTRACT

A wheel cover apparatus for covering the spokes of a bicycle, motorcycle, tricycle, unicycle, wheelchair, wagon, carriage or other terrain vehicles with a first substantially spherical base having a first outer surface and a first inner surface. The first outer surface haves a plurality of ports affixed to the first outer surface. The second substantially spherical base has a second outer surface and a second inner surface. The second outer surface haves a plurality of ports affixed to the second outer surface. The first and second ports each include an inner tubular adjuster positioned to couple the inner surface of said first substantially spherical base to an inner surface of said second substantially spherical base at a predetermined length.

### CROSS-REFERENCE TO RELATED APPLICATIONS

This nonprovisional application is a continuation of and claims priority to U.S. Provisional Application No. 61/962,767, entitled “Wheel Cover Assembly”, filed Nov. 15, 2013 by the same inventor, the entirety of which is incorporated herein by reference.

### BACKGROUND OF THE INVENTION

1. Field of the Invention

The present invention most directly relates to wheel covers for use with bicycle, motorcycle, wheel chair wheels, wagons, carriages, and other similar vehicles. This invention focuses on limiting the potential dangers created by exposed wheel spokes, preventing the ability for fingers, hands, and debris from being caught between the spokes, increasing safety by reflecting or illuminating light to provide awareness of the rider's presence and increasing diversity by providing capabilities to adjust the cover for multiple vehicle use.

2. Brief Description of the Prior Art

Bicycles have been used for transportation, exercise and recreation for many for centuries. The wheels on the bicycles have evolved since their early creation. in the 1800s bicycles appeared with large thin wheels. As time evolved the wheels became more compact and the tires began to vary in size. While the tires and wheels evolved, one feature has remained constant. Spokes on bicycle tires have remained, with some variation since the 1800s. Today spokes are still an important aspect of the bicycle. They are used to support the weight of the rider, to support and strengthen the wheel rim, and to transfer power from pedaling to rotation of the wheel. The spokes are an essential aspect of the bicycle, both bicycles that are powered by motor and bicycles that are powered by mechanical movement, for it to function properly.

However, while spokes provide such a beneficial and necessary use, that use has been accompanied by many existing hazards. The spokes of a wheel perform a vital role to the safety of the vehicle. As such, they need to be protected from damage. A damaged spoke can be the source of accidents. For example, the vehicle can become dangerous to use and can be easily damaged when excessive debris is caught between the spokes. In addition to debris, when the spokes are completely exposed, other items such as fingers and hands can be caught between the spokes, thus potentially injuring an individual. The majority of spokes and tires are made out of dark colored material that do not aid promoting awareness to other users of the road that the vehicle is in use and sharing the road Since the development of bicycles, the hazard that has followed is commonly safety.

One of the more specific issues faced when promoting bicycle safety through spoke covering, is the sizing for the covers, Bicycles, including motorcycles come in different shapes and sizes, and the tires and rims vary in size and width depending on the vehicle. For example, mountain bikes and racing bikes have a variety of tire and rim sizes. When making the vehicle safe, one method is to provide a protective shield to cover the spokes and to prevent potential hazards, but this shield must securely fit around the spokes of the wheel. The variations in rim, type, and tire sizes require different methods of securing such a shield to a wheel. Since a vehicle is most often in motion, the securing mechanism must be strong, secure, and adjustable to account for size changes if used on different vehicles.

These safety concerns are recognized around the world, and some steps have been taken to provide products to the public which attempt to decrease risk of harm, but the conventional art fails to promote diversity in use and transferability between different vehicles. Many current devices and apparatuses are dedicated to the sole purpose of providing cover over the spokes on a wheel of a particular vehicle but do not to allow them to be easily adjustable for diversified use among multiple owned vehicles.

Accordingly, what is needed is a wheel cover apparatus to assist in promoting bicycle and motorcycle safety, white also providing a wheel cover that can be used with multiple sizes and types of wheels for a variety of transport vehicles. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an adjustable wheel cover assembly is now net by a new, useful, and nonobvious invention.

The present invention provides a wheel cover apparatus for safely covering the spokes on a bicycle, motorcycle, wheelchair or similar vehicle to promote safety.

in an embodiment, the wheel cover apparatus comprises a first substantially spherical base having a first outer surface and a first inner surface, said first outer surface having a first plurality of cylindrical or round ports affixed thereto. The cover includes a second substantially spherical base having a second outer surface and a second inner surface, said second outer surface having a second plurality of cylindrical or round ports affixed thereto. The outer surface area of the wheel cover apparatus on the first surface and second surface contains at least one raised area, which allows for aesthetically pleasing designs to be placed. The first and second ports each include an inner tubular adjuster positioned to couple said inner surface of said first substantially spherical base to an inner surface of said second substantially spherical base at a predetermined length.

The inner tubular adjuster is engaged when a fastener is inserted into the first ports of the first outer surface and a fastener is inserted into the second ports of the second outer surface.

An embodiment also provides an inner tubular adjuster that can be manipulated, but rotation or movement to elongate or shorten size.

An embodiment also provides at least a portion of the first inner surface and the second inner surface is covered by an enclosed layer. The enclosed layer creates a compartment between the first inner surface and the enclosed layer and the second inner surface and the enclosed.

An embodiment also includes housing items within the compartment between one of the inner surfaces and the enclosed layer. The types of items that can be housed include batteries, speakers, mp3 players, music players, radios, or any other small electronic device. These items can be housed in the compartment by themselves or in any combination.

The device can be charged by either a power supply such as an AC adapter or USB adapter. It may also run on a rechargeable battery. These charging sources supply power to operate and electronic or mechanical device coupled to the wheel cover apparatus to supply it with power to run property. This includes LED lights that can be coupled to the first outer surface or second outer surface, or for the batteries, speakers, mp3 players, music players, radios, or any other small electronic device requiring power.

It is an objective of the present invention to reduce the risk of accidents resulting from spoke exposure.

it is an objective of the present invention to provide the ability for diversification by allowing a user to use one wheel cover for several similar vehicles.

It is an objective of the present invention to provide protect for the vehicle against potentially damaged spokes.

It is an objective of the present invention to provide a wheel cover apparatus that is aesthetically pleasing and allowing individuals to ride a safe vehicle.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIGS. 1a-1b is are diagrams illustrating the wheel cover outer surface areas of each base.

FIGS. 2a-2b are diagram illustrating the wheel cover inner surface areas of each base.

FIG. 3a is a diagram illustrating the tubular adjuster and fasteners disengaged.

FIG. 3b is a diagram illustrating the tubular adjuster and fasteners engaged.

FIG. 4 is a diagram illustrating the cross sectional view of wheel cover.

FIG. 5 is a diagram illustrating the wheel cover assembly.

FIG. 6a is an exploded view of an embodiment of the current invention.

FIG. 6b is a partial exploded, perspective view of the embodiment of FIG. 6a.

FIG. 6c is a partial exploded, perspective e of the embodiment of FIG. 6a.

FIG. 7a is a front view of an embodiment of the current

FIG. 7b is a side view of the embodiment of FIG, 7a

FIG. 7c is a rear view of the embodiment of FIG. 7a.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

While specific examples are provided for bicycles, the application describe herein is not limited thereto. The wheel cover is intended to cover wheels for motorcycles, unicycles, tricycles, scooters, wheelchairs, carriages, wagons, carts, buggy or other similar wheeled vehicles, which will be referred to as terrain vehicles for the purposes of this application.

Implementation details of certain embodiments of the invention are described below by way of more specific functional components.

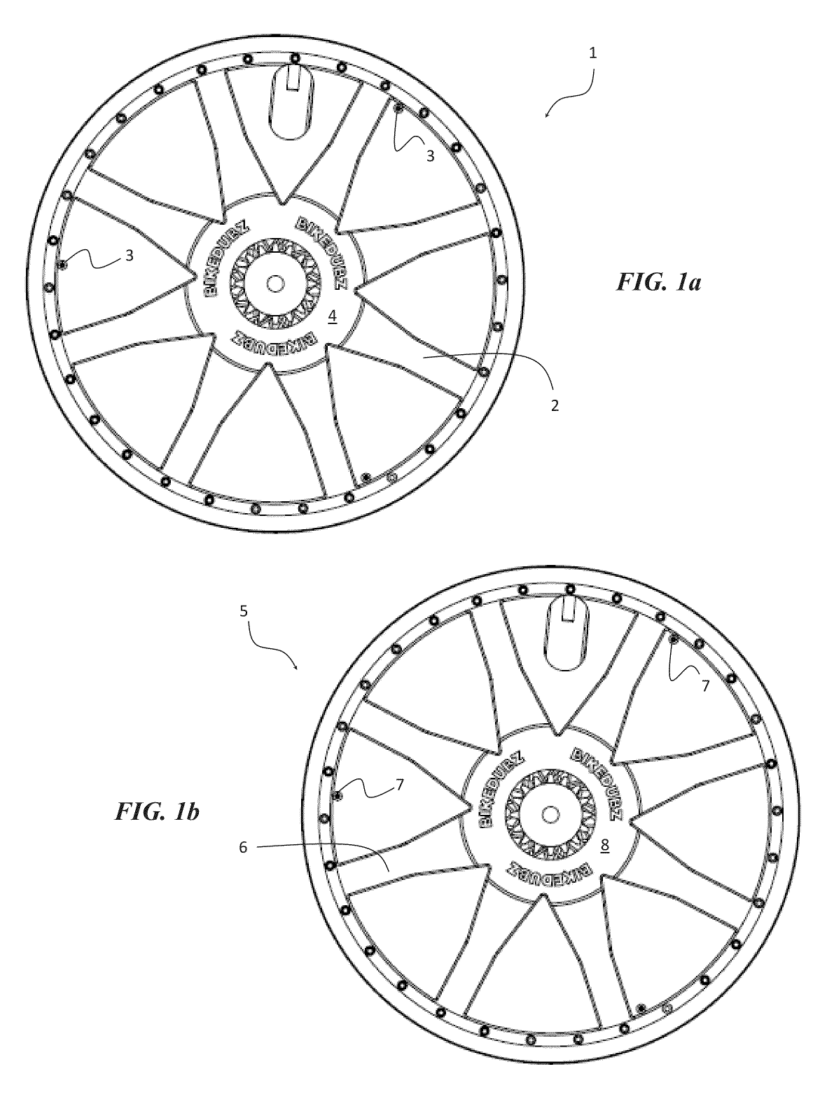

As is illustrated in FIG. 1a, the present invention is composed of a first substantially spherical base 1 having a first outer surface 2. The first outer surface 2 having a first plurality of ports 3 affixed around the periphery of each base. The ports may be cylindrical or tubular or round in shape (or other suitable shape) and protrude in an inward direction in relation to the respective base 1,5. The first outer surface 2 may be configured to include at least one raised area 4, which highlights and accentuates the dimensions of the outer surface.

FIG. 1b also illustrates a second substantially spherical base 5 having a second outer surface 6. The second outer surface 6 having a first plurality of ports affixed thereto 7. The second outer surface 6 includes at least one raised area 8, which highlights and accentuates the dimensions of the outer surface. It is to be noted that the shape of each are not limited thereto and can also be formed according to specifications desired by an end user

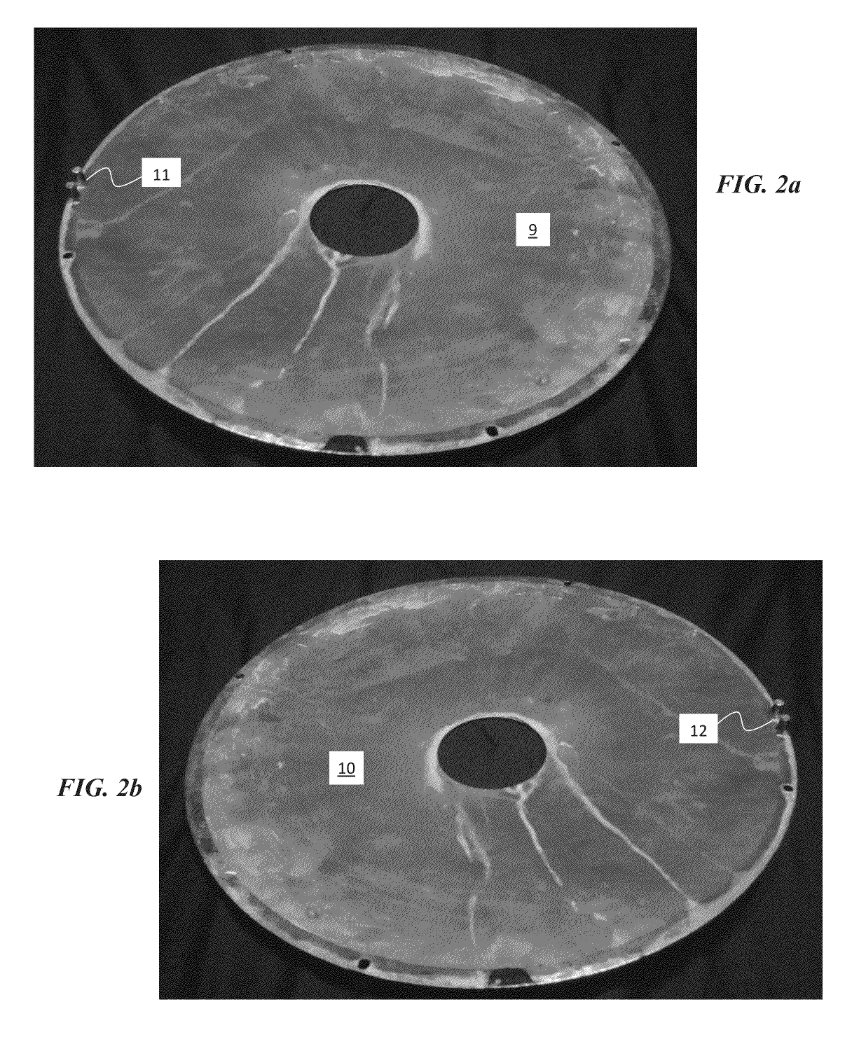

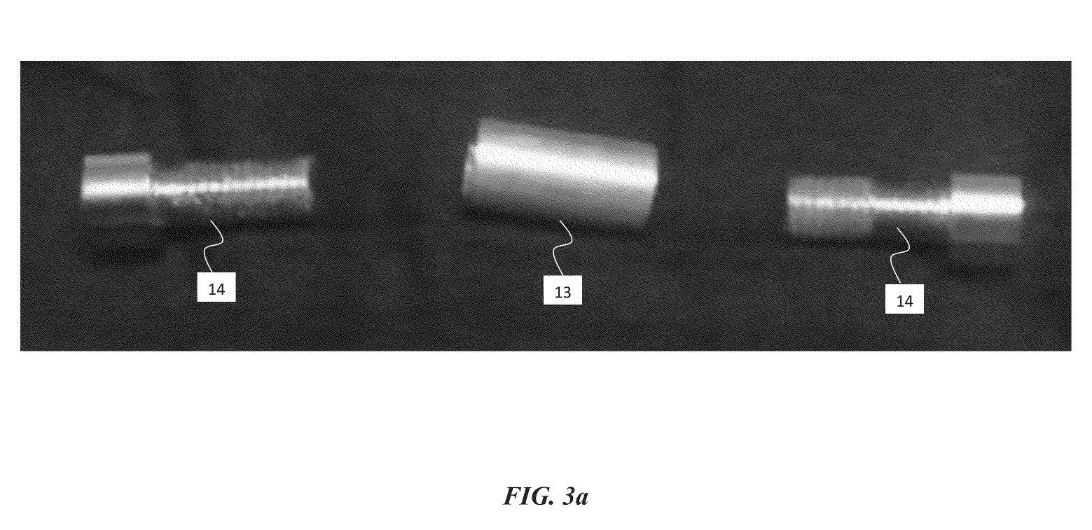

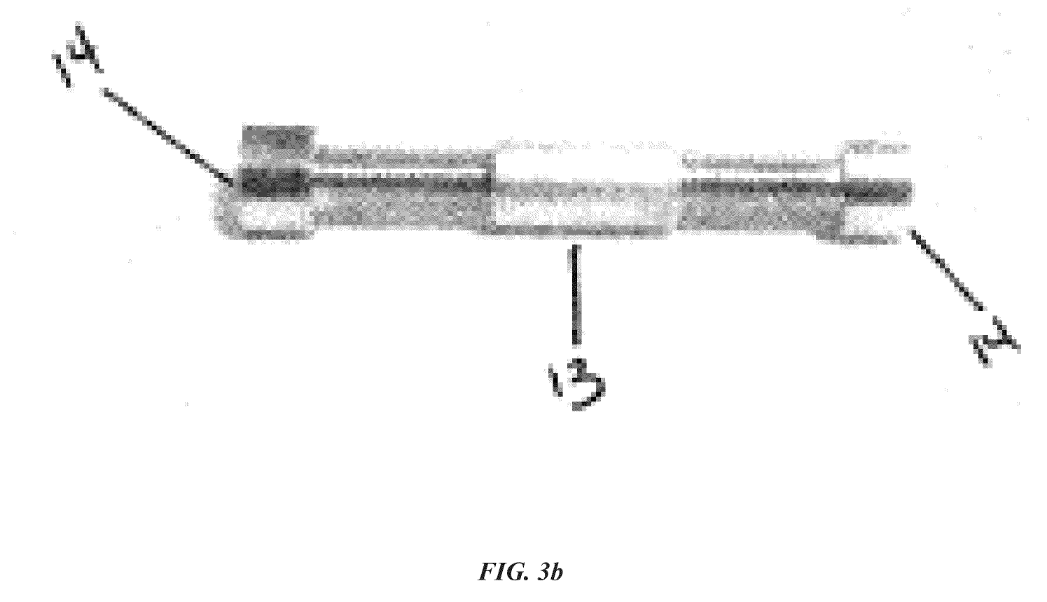

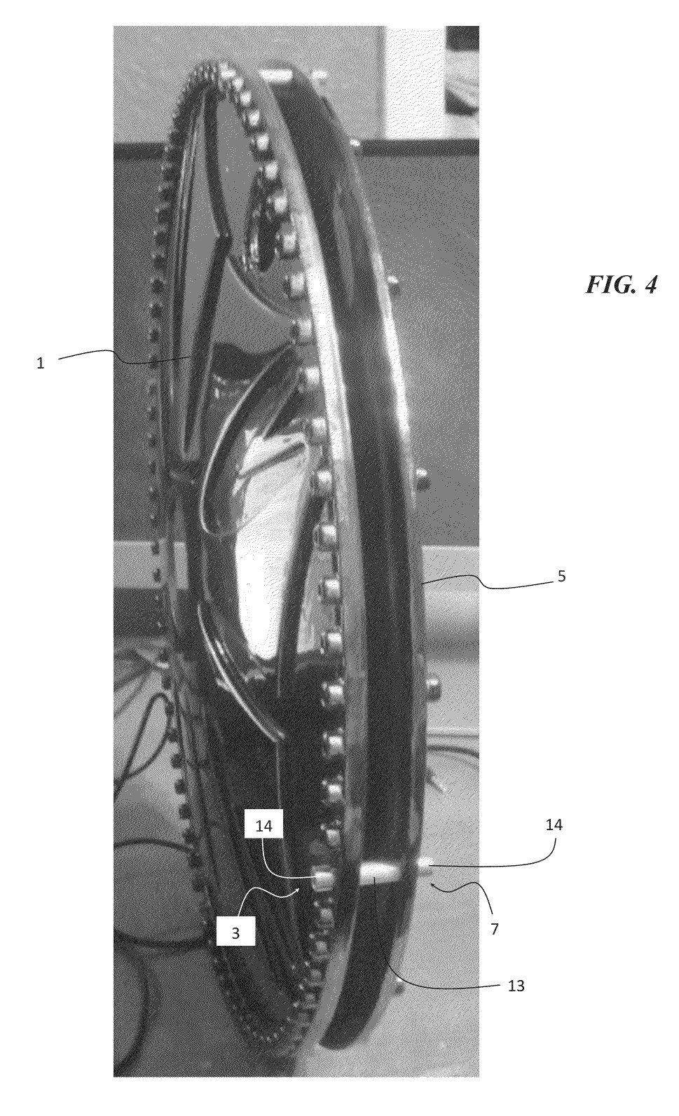

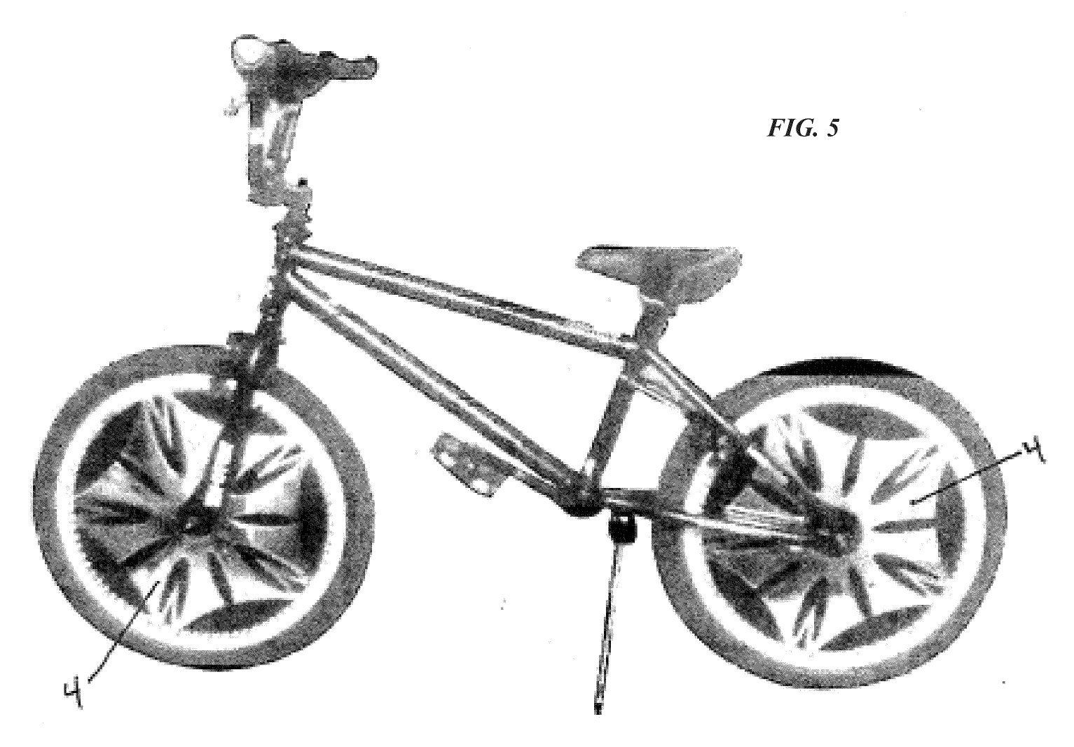

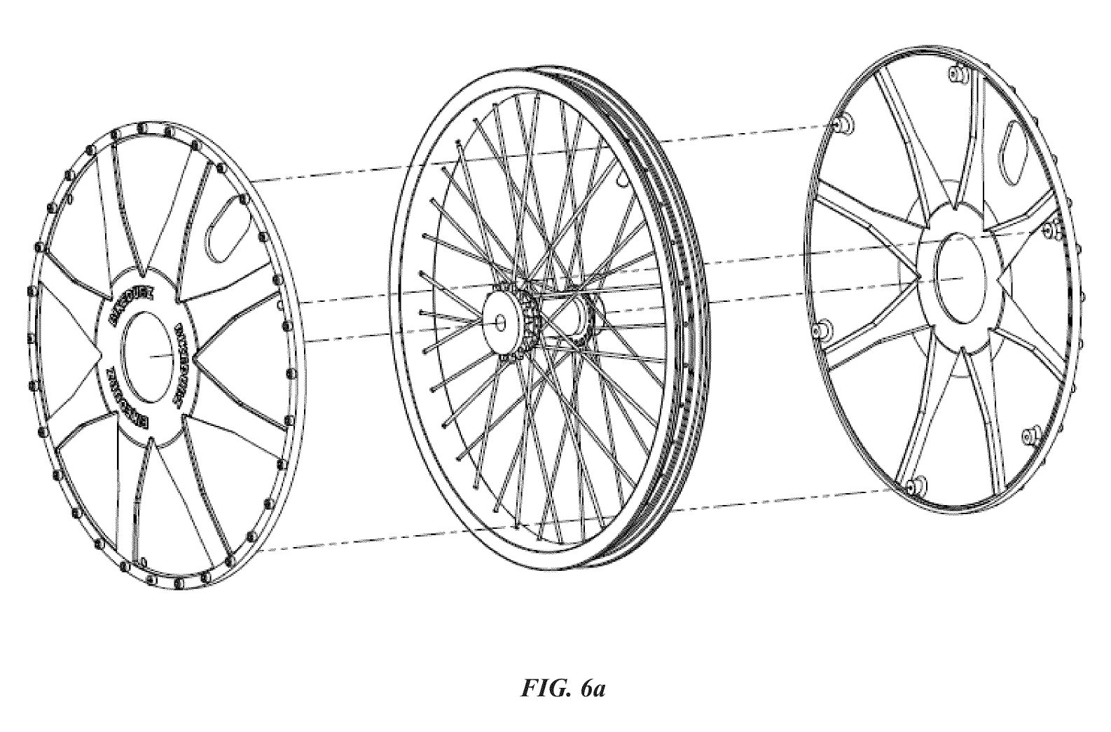

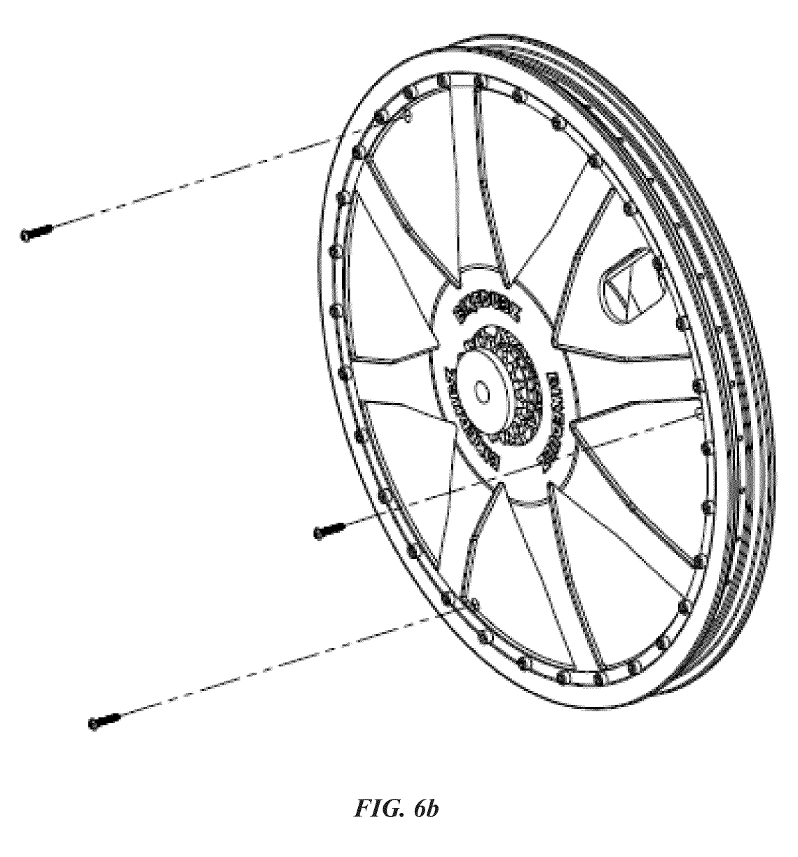

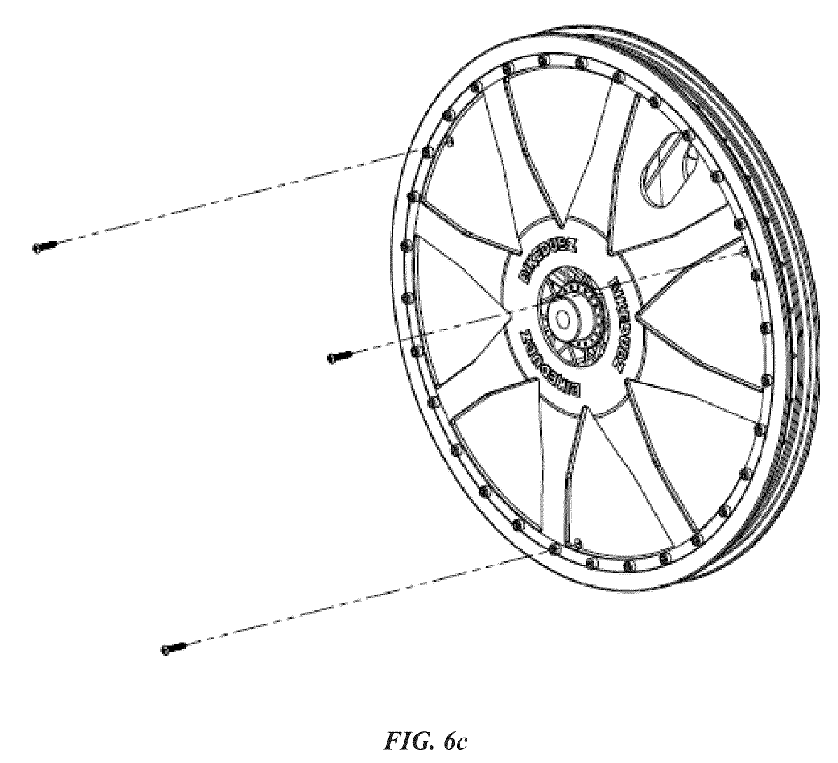

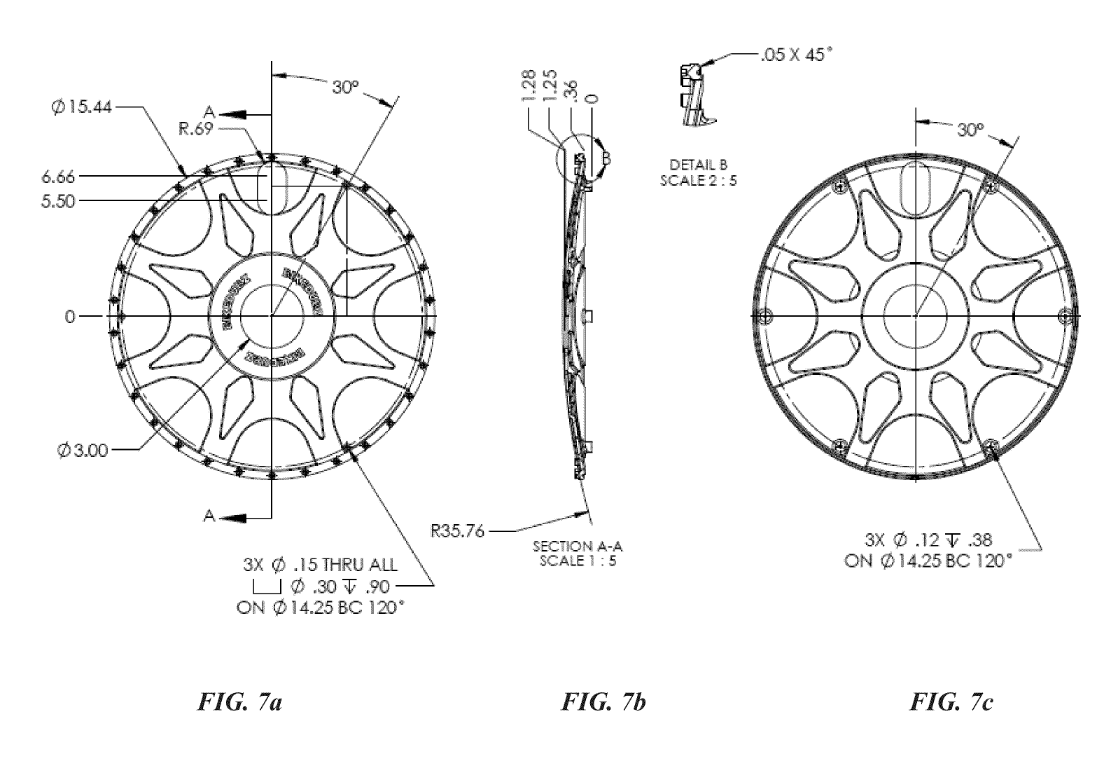

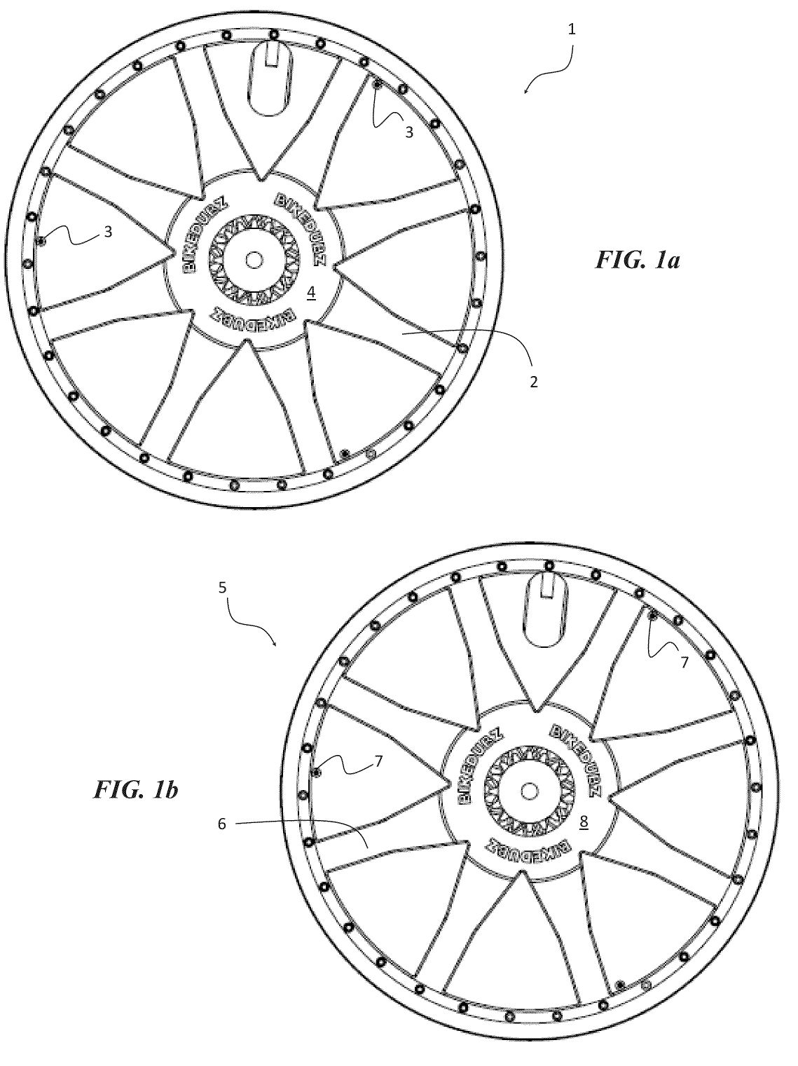

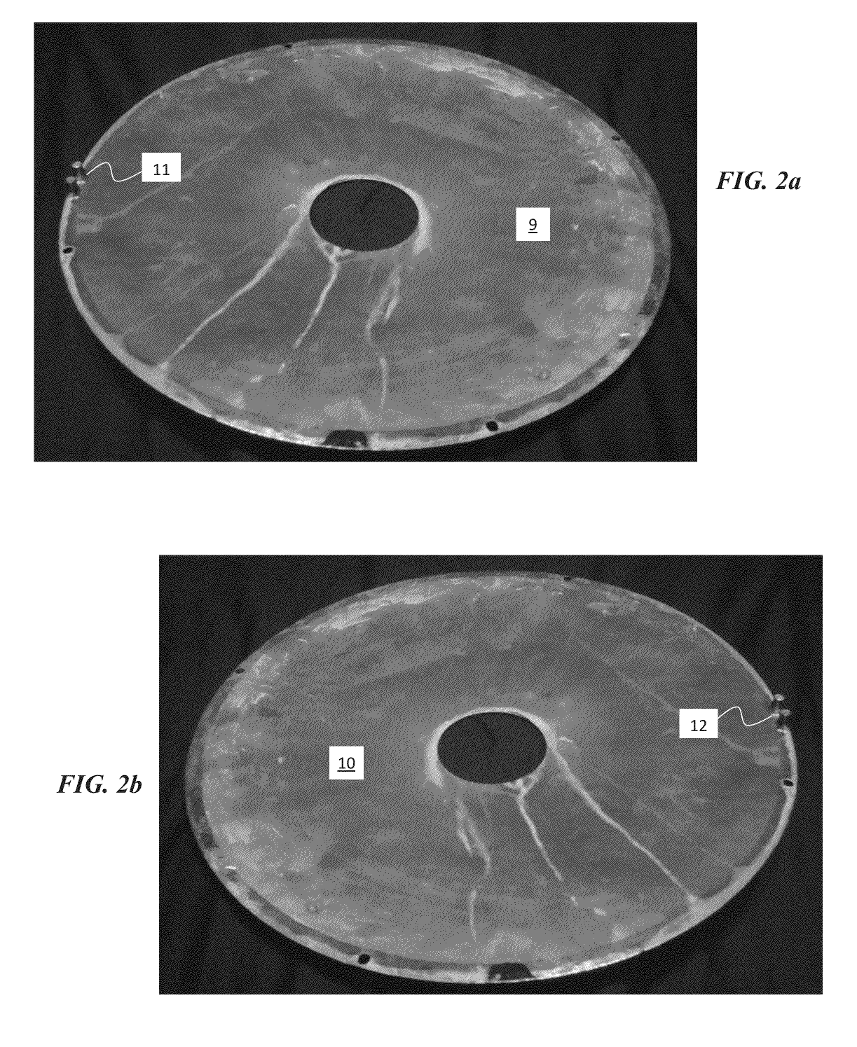

As shown in FIGS. 2a-2b, all elements or components serve the same purpose as elements or components, respectively, described above with reference to FIG. 1. Additionally, FIGS. 2a-2b show a first inner surface 9 and a second inner surface 10. The first inner surface 9 and second inner surface 10 of the first substantially spherical base 1 and second substantially spherical base 5, respectively, are arched. This arching effect would follow the contours of the spokes of the vehicle.

In an embodiment, the first inner surface 9 of the first base 1 comprises two protruding members 11. These protruding members 11 are used to protect the air valve. The air valve is located on the vehicle tire; when the first substantially spherical base 1 is placed over the tire spokes, the air valve is placed between the two protruding members 11. This prevents the first substantially spherical base 1 from shifting during vehicle use and damaging and air valve. The protruding members 11 also prevent the inner surface 9 of the first substantially spherical base 1 from hitting the spokes.

The second inner surface 10 of the second base 5 comprises two protruding members 12.

These protruding members 12 are used to protect the air valve. The air valve is located on the vehicle tire; when the second substantially spherical base 5 is placed over the tire spokes, the air valve is placed between the two protruding members 12. This prevents the second substantially spherical base 5 from shifting during vehicle use and damaging and air valve. The protruding members 12 also prevent the inner surface 10 of the second substantially spherical base 5 from hitting the spokes.

The first substantially spherical base 1 and second substantially spherical base 5 are made from a non-transparent material. The non-transparent material is plastic material or a metal. The types of plastic material that preferred are PC: Polycarbonate, HIPS: High impact Polystyrene, ABS: Aclylonitrate Butadiene Styrene, HDP: High Density Polyethylene, Utility HIPS: Recycled High impact Polystyrene, PETG: Glycol Infused Polyethylene Terephthalate, RPET: Recycled Polyethylene Terephthalate, PVC: Rigid Polyvinyl Chloride, Acrylic: Polymethyl Methacrylate, and Co-ex: Co-extruded Plastics; while these plastics are preferred other strong light weight plastics maybe used. The types of metal material preferred include Low Carbon Steels, Medium Carbon Steels, High Carbon Steels, Stainless Steel, Aluminum/Aluminum alloys, Brass, Lead, Magnesium/Magnesium Alloys, Nickel/Nickel Alloys, Titanium/Titanium Alloys, Zinc/Zinc Alloys, Gold, Silver, and Platinum; while these metals are preferred other strong, durable metals maybe used.

The process of creating the first substantially spherical base 1 and second substantially spherical base 5, involve various techniques to insure the durability, the strength, and aesthetically pleasing customized designs. These manufacturing techniques for constructing the first and second substantially spherical base include Injection molding, Metal injection molding, Vacuum forming, Die casted, Reaction injection molded, Thin-wall injection molding, Forging, and CNC Machined; while these are some of the techniques used for creating the first substantially spherical base 1 and the second substantially spherical base 5, these are not the only techniques that may be used.

In another embodiment, the first outer surface of the first substantially spherical base and the second outer surface of the second substantially spherical base have the ability to illuminate. This is accomplished with glow in the dark paints and coatings. This is also accomplished by placing LED lights on the first outer surface of the first substantially spherical base and on the second outer surface of the second substantially spherical base. A screen can be coupled to the first outer surface of the first substantially spherical base and on the second outer surface of the second substantially spherical base allowing images, video, and other multimedia to be displayed.

Terrain vehicle wheels are a variety of sizes. The first substantially spherical base 1 and the second substantially spherical base 5 are also available in a variety of sizes, in order to appropriately cover the spokes of the vehicle.

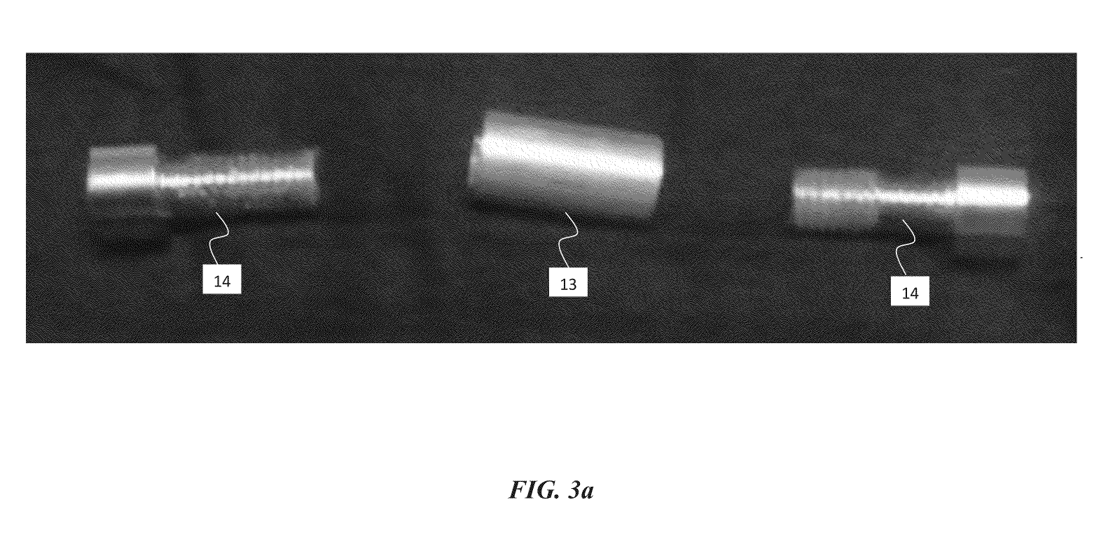

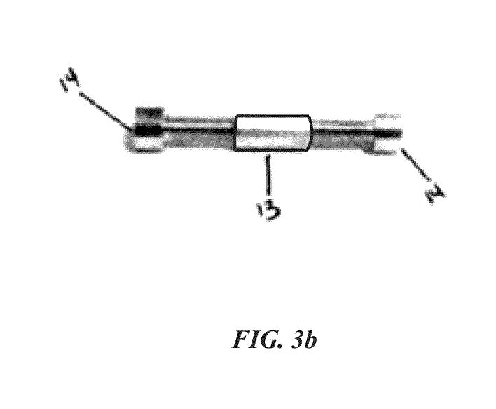

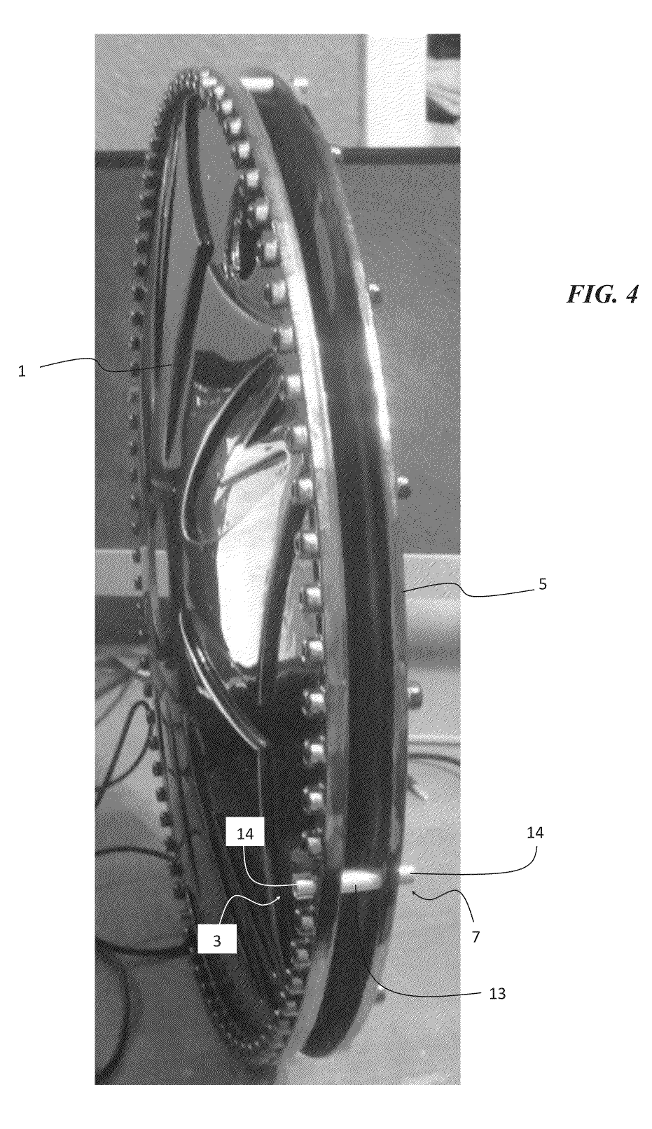

A tubular adjuster 13 is positioned to couple the first inner surface 9 of the first substantially spherical base 1 to the second inner surface 10 of the second substantially spherical base 5, as in FIGS. 3a-3b. This is accomplished using the plurality of ports 3,7 affixed to the first outer surface 2 and to the second outer surface 6. A fastener 14 is used to secure the connection. The fastener 14 is inserted on the first outer surface 2 of the first substantially spherical base 1 and on the second outer surface 6 of the second substantially spherical base 5. In FIG. 4, the first substantially spherical base 1 and the second substantially spherical base 5 have been aligned, such that the first ports 3 of the first substantially spherical base 1 and the second ports 7 of the second substantially spherical base 5 are identically and evenly spaced and positioned such that the fasteners 14 and the tubular adjuster 13 will connect the first substantially spherical base 1 and second substantially spherical base 5. The inner tubular adjuster 13 is engaged when a fastener 14 is inserted into the first ports 3 of the first outer surface 2 and a fastener 14 is inserted into the second port 7 of the second outer surface 6. The fasteners 14 are inserted into the tubular adjuster 13. Due to the length of the tubular adjuster 13, the fasteners 14 are only inserted as far as necessary to provide secure coverage for the width of the vehicle rim, as in FIG. 3b. The tubular adjuster 13 is a predetermined length based on the width of the terrain vehicle wheel being used. At least four fasteners are used for the first outer surface and at least 4 fasteners are used for the second outer surface.

In another embodiment, the tubular adjuster can be adjustable to meet the width requirement of the different terrain vehicles. The tubular adjuster can be adjusted by a turning rotation on one portion of the tubular adjuster that allows the tubular adjuster to elongate or shorten; such that it may be adjusted to fit different terrain vehicle rim widths.

In another embodiment, the tubular adjuster can be adjustable to meet the width requirement of the different terrain vehicles. The tubular adjuster can be adjusted by a pushing and pulling movement on one portion of the tubular adjuster that allows the tubular adjuster to elongate or the shorten, such that it may be adjusted to fit different terrain vehicle rim widths.

Other suitable methodologies of adjusting the length of the tubular adjuster are contemplated by the current invention as well.

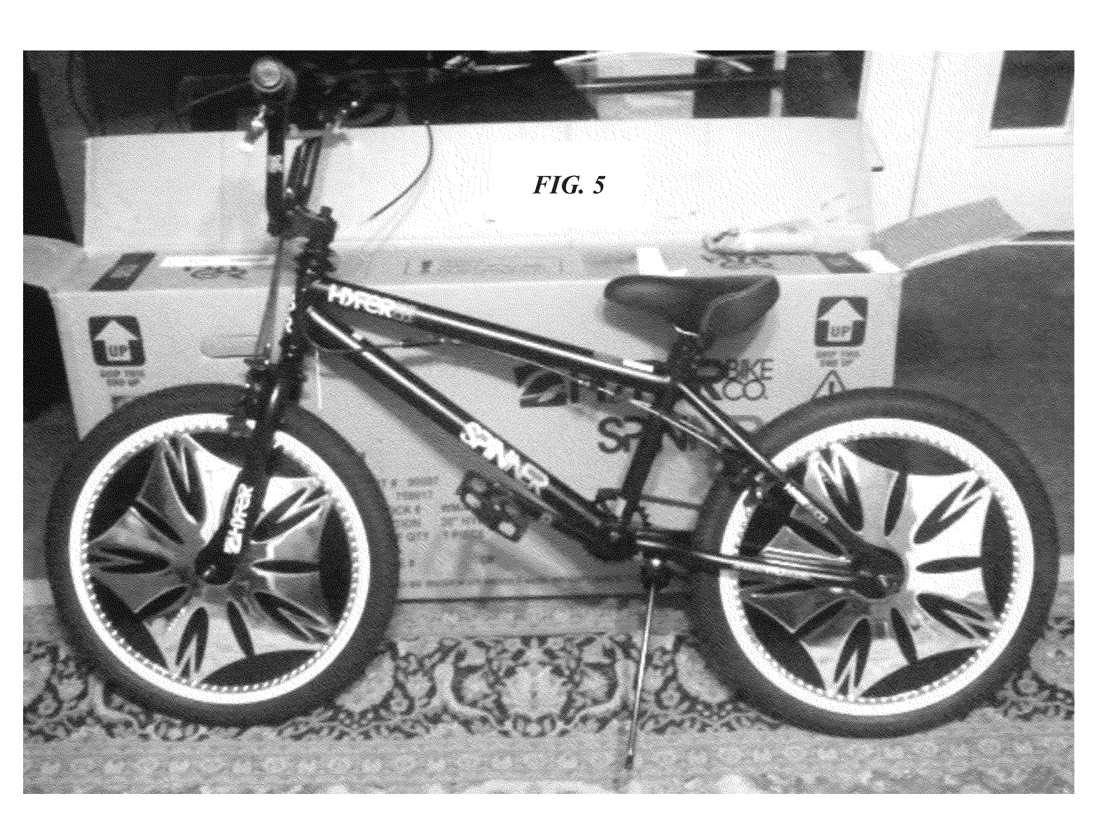

The wheel cover is placed on the terrain vehicle as in FIG. 5, The raised areas 4 on the outer surface of the first and second wheel covers are various colors and designs. A reflective coating material is used in sections of the surface area and can be used on the entire surface area. To achieve this look, primary chrome, colors which are reflective and mirror like are used in colors such as black, blue, brown, gray, green, orange, pink, purple, red, white, yellow and any other chrome color available to provide the reflective and mirror like appearance. In addition, the wheel covers can be coated in materials that do not contain reflective properties. Alternate paint colors can be used, as well as color changing paint, in colors such as black, blue, brown, gray, green, orange, pink, purple, red, white, yellow and any other colors that are available.

Various techniques are used to coat the first outer surface and the second outer surface, which can be reflective or non-reflective these techniques include but are not limited to Chrome plating, Vacuum coating, Spray on chroming, Spray painting, High velocity oxygen fuel (HVOF), Plasma spraying, Thermal spraying, Plasma transferred wire arc thermal spraying, the common forms of Powder coating, Conversion coating, Anodising, Chromate conversion coating, Plasma electrolytic oxidation, Phosphate (coating), Ion beam mixing, Pickled and oiled, a type of plate steel coating, Plating, Electroless plating, Electroplating, Adhesive, Cathodic arc deposition, Electron beam physical vapor deposition (EBPVD), Ion plating, Ion beam assisted deposition (IBAD), Magnetron sputtering, Pulsed laser deposition, Sputter deposition, Vacuum deposition, Vacuum evaporation, evaporation (deposition), Air knife coating, Anilox coater, Flexo coater, Gap Coating, Knife-over-roll coating, Gravure coating, Hot Melt coating, Immersion (dip) coating, Kiss coating, Metering rod (Meyer bar) coating, Roller coating, Forward roller coating, Reverse roll coating, Silk Screen coater, Rotary screen, Slot Die coating, Inkjet printing, Lithography, Hexography, dip coating, Tensioned-web slot die coating, Slot die bead coating, Slide coating, Curtain coating, and Extrusion coating. In addition, other similar techniques may be used.

In another embodiment, the first substantially spherical base, with the first inner surface has an enclosure layer. The enclosure layer covers at least a portion of the first inner surface. The second substantially spherical base, with the second inner surface has an enclosure layer. The enclosure layer covers at least a portion of the first inner surface. This enclosure layer on the first substantially spherical base, first inner surface and on the second substantially spherical base, second inner surface may house items within its enclosure. Items such as batteries may be housed within the enclosure layer. In addition, items such as mp3 players, music players, and radios may also be housed within the enclosure layer. Another item that may be housed within the enclosure layer are speakers. The enclosure layer is similar to an empty pocket which may house many different items.

In an embodiment, the present invention is charged by a power supply connected to power supply cord located within the first substantially spherical base and the second substantially spherical base. The power supply provides power to allow for the charging of LED lights which are affixed to the first outer surface and to the second outer surface. The power supply also generates a charging power for the mp3 player, music player, radio, or speakers feature of the invention. It also re-charges the batteries featured in this invention. It may also be powered by use of an AC adapter, USB adapter or other power sources known to one of ordinary skill in the art.

The present invention is intended to embrace all such alternative implementations, and others that will be apparent to the skilled artisan upon review of this disclosure. The descriptions above are intended to illustrate possible implementations of the present invention and are not restrictive . Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalence.

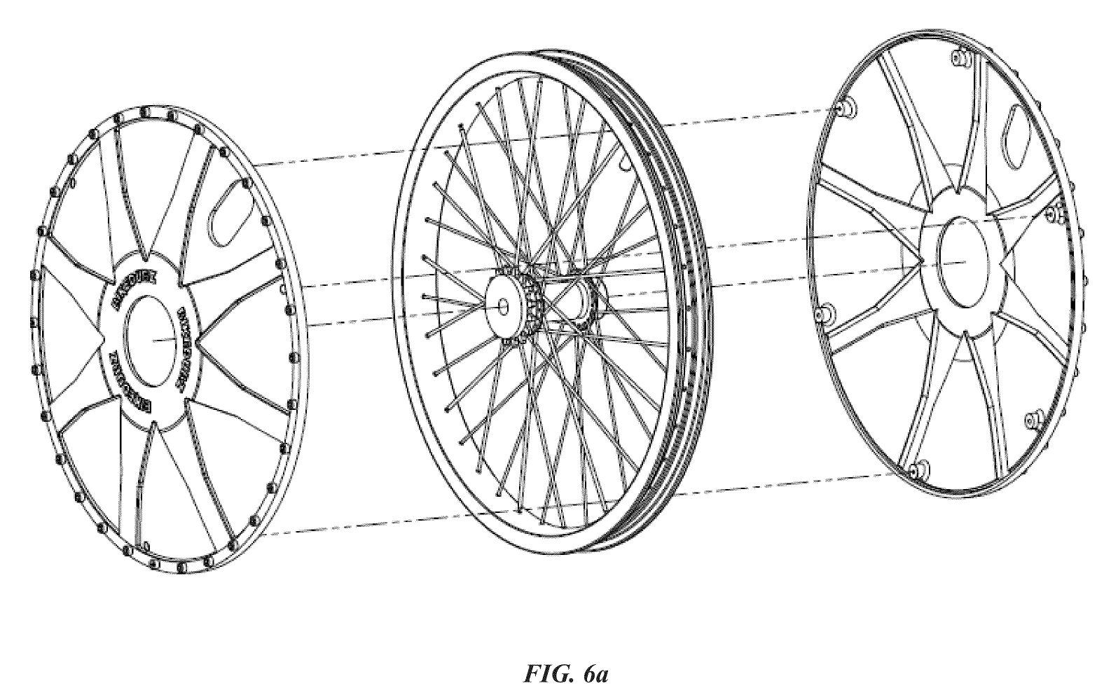

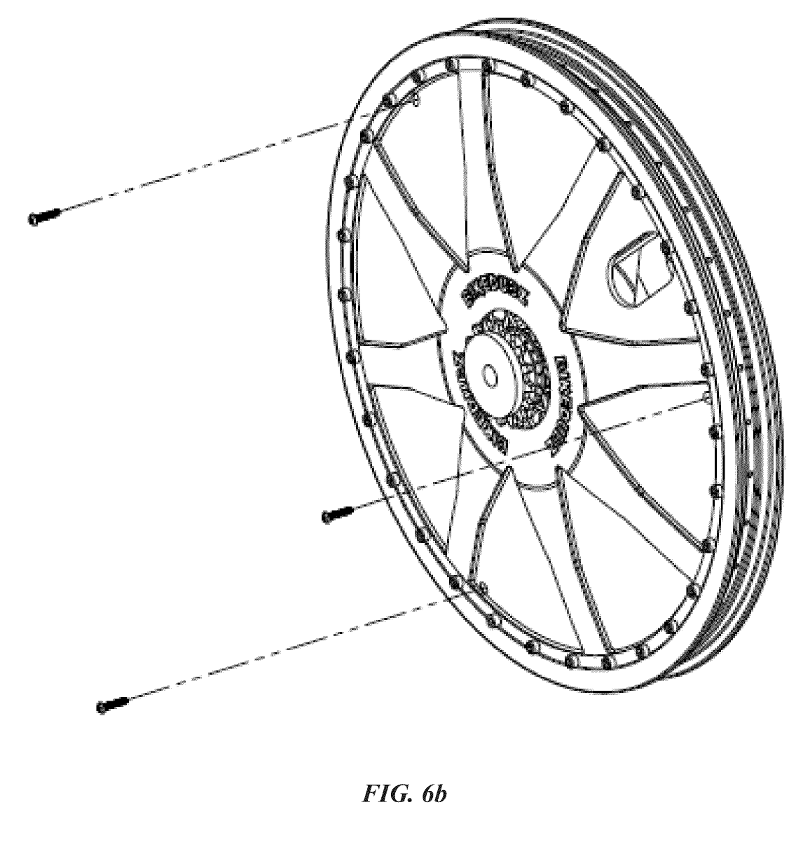

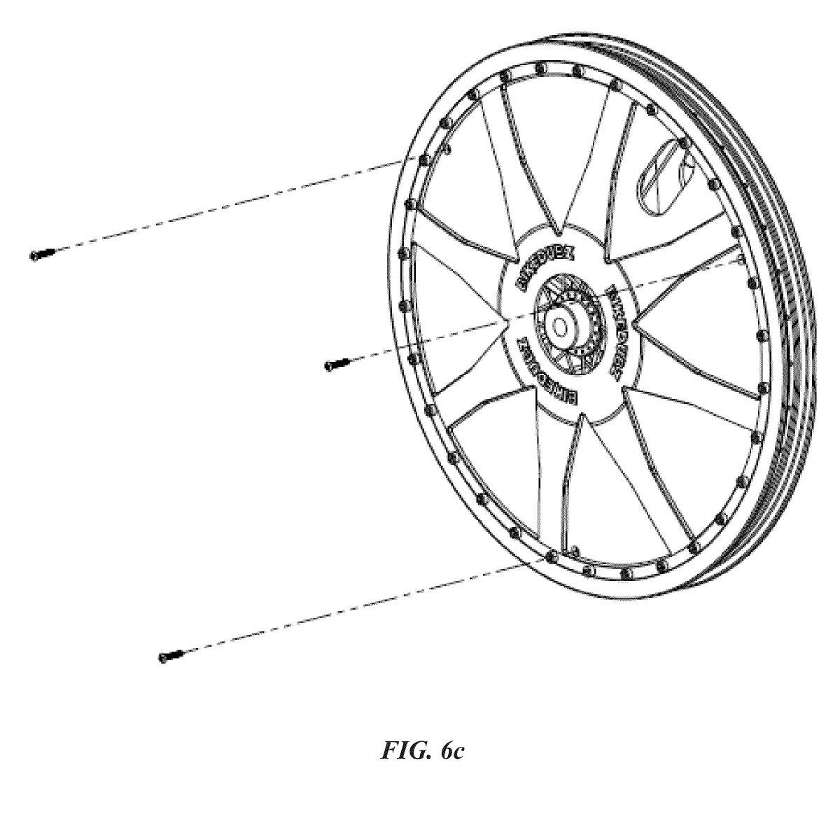

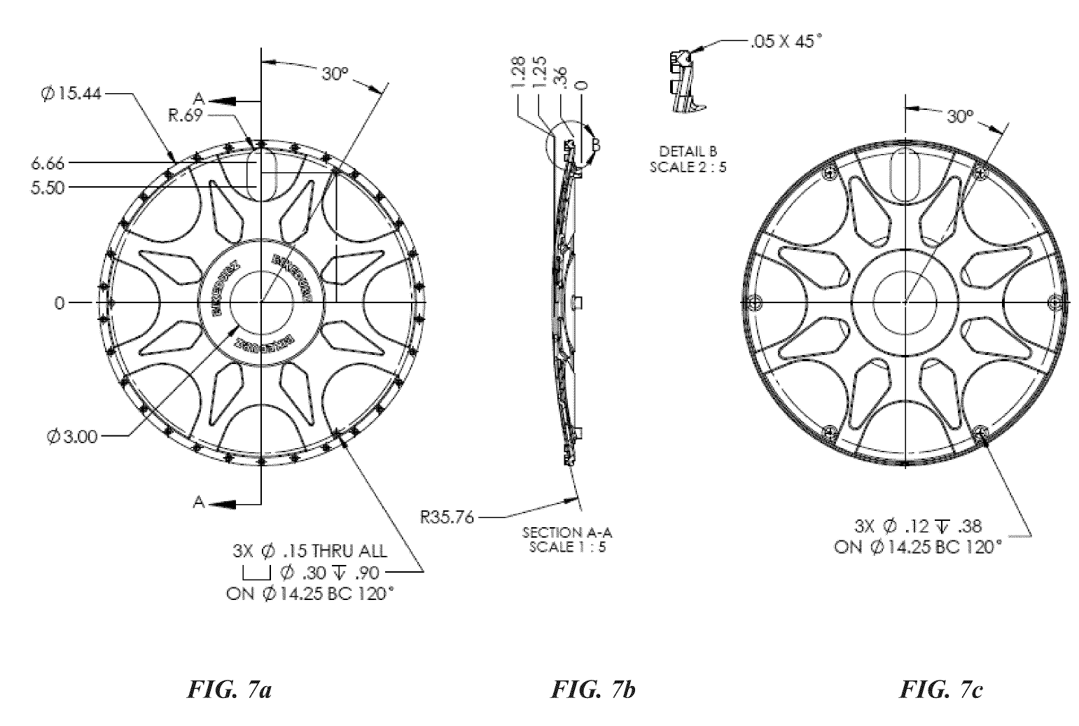

FIGS. 6a-6c and 7a-7c depict embodiments of the current invention. FIGS. 6a-6c primarily show the mechanism of assembling the wheel cover system in exploded views. FIGS. 7a-7c primarily are different views of a single spherical base.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to he understood that the following claims are intended to cover all of the generic and specific features of the invention herein described, and all statements of the scope of the invention that, as a matter of language, might be said to fall therebetween.

What is claimed is:

1. A wheel cover apparatus comprising:
a first substantially spherical base having a first outer surface and a first inner surface, said first outer surface having a first plurality of ports affixed thereto; and
a second substantially spherical base having a second outer surface and a second inner surface, said second outer surface having a second plurality of ports affixed thereto, wherein said first and second ports each include an inner tubular adjuster positioned to couple said inner surface of said first base to an inner surface of said second base at a predetermined length.

2. The wheel cover apparatus as recited in claim 1, wherein the inner tubular adjuster is engaged when a fastener is inserted into the ports of the first outer surface and second outer surface.

3. The wheel cover apparatus as recited in claim 1, wherein the first base having ports and the second base having identically spaced and positioned ports.

4. The wheel cover apparatus as recited in claim 1, wherein at least a portion of the first inner surface is covered by an enclosed layer; and at least a portion of the second inner surface is covered by an enclosed layer.
